(19) United States
(12) Patent Application Publication
(10) Pub. No.: US 2011/0258203 A1
(43) Pub. Date: Oct. 20, 2011

(54) METHODS AND SYSTEMS FOR RELATIONSHIP CHARACTERIZATION AND UTILIZATION FROM A USER'S SOCIAL NETWORKS

(76) Inventors: Rita H. Wouhaybi, Portland, OR (US); Mark D. Yarvis, Portland, OR (US)

(21) Appl. No.: 12/761,448

(22) Filed: Apr. 16, 2010

(51) Int. Cl. G06F 17/30

(52) U.S. Cl. 707/749; 707/802; 707/769; 707/783; 707/E17.005; 707/E17.014; 707/E17.044

(57) ABSTRACT

An embodiment of the present invention provides a method of relationship characterization and utilization from a user's social network, comprising, using monitoring agents for the user's social network to create a unique profile of each contact in the social network by feeding data into a context aware framework, clustering raw data by extracting common interests and relevant keywords, thereby creating rich context-aware lists of keywords that characterize relationships among users of the social networks, and providing an interface to query the lists.

### BACKGROUND

Current consumer services and shopping sites, often provide users with ratings and reviews of products and services. These reviews often come from one of two sources: either experts in the subject matter (e.g. Cnet.com) or individuals who logged their reviews on public sites (e.g. shopping.com, Amazon etc.). In real life, most people trust their social network and even when checking reviews online, they then try to figure out who of their social network would be the best bet to inquire about their previous experience and opinion about a product or a service.

Thus, a strong need exists for methods and systems for relationship characterization and utilization from a user's social networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a system architecture for creating and using tags clouds according to embodiments of the present invention; and

FIG. 2 depicts an example of tags clouds for Users B & C, as Perceived by User A and for User C as Perceived by User D according to embodiments of the present invention;

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Embodiments of the present invention may be of great value in several fields for information customization and personalization, whether it is in the mobile market or home entertainment devices. Providing context relevant and personalized information from a social network is of high value to consumers and embodiments of the present invention may allow entities to run and monetize the cloud service where agents can collect and store the data. Thus, for example and not by way of limitation, smartphones will be able to show the most relevant information of interest to a user including ads, applications to install, incoming messages from other users depending on their context, and other profitable usage models.

Original equipment manufacturers would be interested in including such services in their products, as follows: Mobile providers and manufacturers might want these services in order to provide better recommendations and data delivery for users on the go. Home entertainment manufacturers and cable companies would also be interested in providing such services and building usage models. Online social network services (such as Facebook®, LinkedIn® and Twitter®) would benefit in directing data traffic using embodiments of the present invention. As used herein, social networks may include but is not limited to, all contacts, family, friends, acquaintances, businesses and the like. It may also include groups or clubs (for example, but not limited to, a knitting group, play groups, sporting groups, any enthusiast groups, fan clubs, booster clubs etc.); or even an institution (for example, but not limited to, Bank of America, Consumer Reports, etc.).

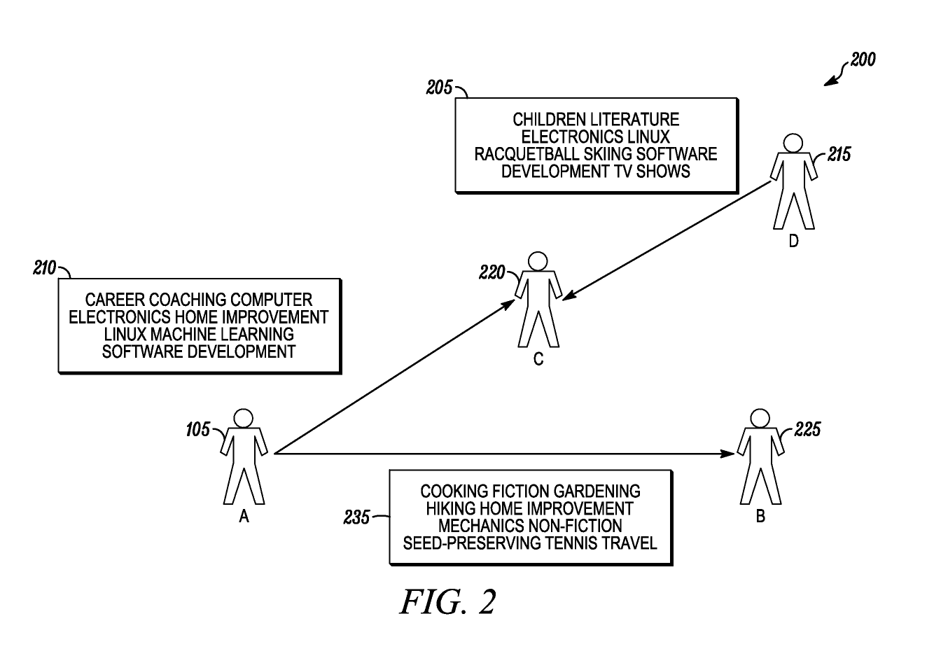

Embodiments of the present invention provide a platform that would monitor relationships among individuals or other entities in one's social network, in order to detect and define the context of these relationships. This may be accomplished by extracting keywords related to a relationship. In addition, using the frequency of use of these keywords, the present invention may define their respective weights. In one embodiment, as shown in FIG. 2 and described in greater detail below, the constellation of these keywords creates what we may be defined herein as a “tag cloud id”. Current social networking services and sites define a social graph. Embodiments of the present invention characterize each edge with the relevant topic/subject categories and weights, in an automated way. It is understood that the present invention is not limited to utilization of any particular social networking site or service or subscription or communication methodology and the present invention may be used to characterize a user's social network in general, irrespective of subscriptions to any social network service (e.g., but not limited to Facebook or LinkedIn) or not.

It is noted that the cloud ids are used as a visual representation. In reality, embodiments of the present invention are creating, storing and using weighted lists of keywords that characterize relationships among users. In one usage model of this invention, and not limited in this respect, the clouds created are used to match persons in one's social network to keywords and possibly sending a request for information and/or querying published data. For example, assume that a user is in the market for a TV. Once this interest is detected by the present invention, it will look through the social network to extract relevant persons, using the cloud of tags. It can then look for the reviews and comments submitted by these individuals and/or show the user a list of these individuals. One's network, as used herein, may be defined as all of the user's interactions in life with other individuals and groups.

As mentioned above, embodiments of the present invention may use context information in order to build a cloud of words that characterizes an individual's relationships with people in his/her social network. It may also use the same concept in order to characterize a person's own interests. These tags clouds can then be used by several applications to query the relevant members of a social network for information or to publish relevant data to them. Again, it is noted that the clouds are visual representation of weighted lists of keywords that this invention creates, stores and makes available for applications.

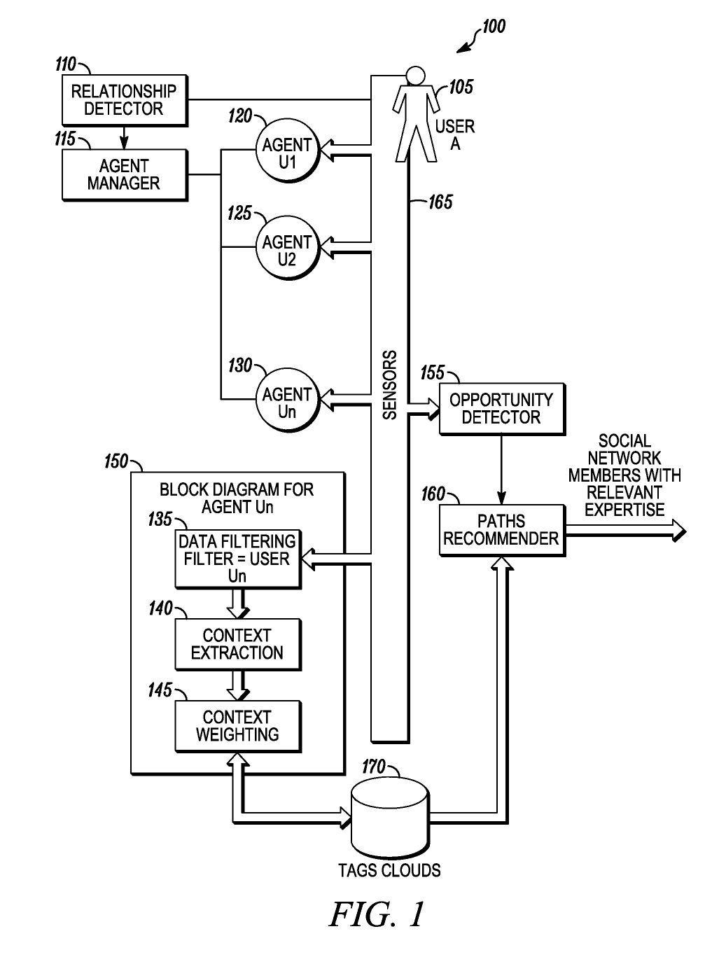

Looking now at 100 of FIG. 1 is generally showing the different modules and their interaction. In addition, FIG. 2 at 200 generally shows an example of tags clouds for a set of users. The modules of FIG. 1 are for user A 105 and are described as follows:

Sensors 165: these can be software or hardware sensors for user A 105, such as an email scanner that will monitor communication with user A 105 or a physical proximity sensor that can detect persons nearby user A 105. Other examples of sensors include updates and information published to social networking sites such as LinkedIn® and Facebook®, just to exemplify a couple—and it is understood the present invention is not limited to these or any particular social networking site. Sensors can also include explicit user input. Further sensors may include, but are not limited to, software such as Instant Messaging or VoIP (e.g., Skype®); cell phones such as text messaging and phone calls and others such as microphones or other identity inputs such as face recognition, just to name a few. To exemplify, but not by way of limitation, the aforementioned software may be a sensor monitoring a phone call log on a cell phone; or a software sensor monitoring SMS traffic on a cell phone or IM traffic on a PC. To further exemplify, but not by way of limitation, the aforementioned hardware may be a microphone listening to conversations in a room or on a cell phone call; and/or a camera monitoring the set of people in a room.

Relationship Detector 110: This module will sift through the sensors raw data. Once it detects that communication and contact with another person (User B, shown as 225 of FIG. 2) has exceeded a certain threshold (e.g., count, duration, etc.), it will inform the Agent Manager 115 about all the information it knows about User B 225. This information might include identity information (such as name, email, locations, etc.) as well as frequency and means of contact. This information is the first “draft” of the tags cloud which will be refined by the Agent with more time and data collected by the sensors.

Agent Manager 115: This module is responsible for creating and disposing of agent modules (e.g., Agent U1 120, Agent U2 125, and Agent Un 130) that are responsible for monitoring exchanges and communications with specific users. When it receives information about a user from the Relationship Detector 110, it makes sure that the user is not already being tracked by an agent. If not, it then spawns a new Agent (three agents shown 120, 125 and 130) that would track the relationship with that user. It may also terminate an agent if the need be (user is no longer in social network or 2 agents were discovered to be monitoring the same user, their info can be merged and one of the agents will be terminated).

Agents 150: Embodiments of the present invention may have an agent per user tracked as can be seen in FIG. 2. Each user is a person or a group with interactions with the subject user (User A 105 in this example).

The lower left block 150 shows the different modules inside an agent, which may include:

Data Filtering 135: an agent monitors raw data reported by sensors. It filters that data to include only those relevant to User N, using the identity information it has (e.g., the user's e-mail address, phone number, voice characteristics, etc).

Context Extraction 140: this module takes the raw data of the interaction between User A 105 and User N and extracts from it the relevant metadata. It does that using a variety of techniques which could include, but not limited to, keyword clustering techniques (such as those known to one of ordinary skill in the present art; for example and not by way of limitation, the Google Sets®) as well as linguistic methods (such as those known to one of ordinary skill in the present art; for example and not by way of limitation, Princeton WordNet). It generates a list of keywords based on the interaction. For example, this module might decide after scanning an email exchange between User A 105 and User N (not shown), that the main keywords for that specific interaction are “tennis” and “weather”.

Context Weighing 145: this module uses the frequency of interaction as well as other interaction context information in order to decide the weight of each keyword. It also has access to User A's 105 repository of tags clouds 170 of users in its social network. For example, it might decide that the word “tennis”, in the cloud corresponding to the interactions with User B, should get an updated relative weight of 15%, while the word weather will be 0.01%. In the case that the tag cloud is displayed visually, this might translate to increasing the size of the word “tennis” but merely keeping track of the word “weather” in future interactions without having it appear in the cloud for now. This module also updates the self-tag cloud in the repository of tag clouds 170 that represents his own interests (in this example, User A).

An example of the tags clouds 205, 210 and 235 is shown in FIG. 2. Tags 210 and 235 are created on behalf of User A 105 for User B 225 and User C 220. Note that these clouds represent the context of relationships between users from the point of view of User A 105. Another User D 215 might have totally different tags clouds for User B 225 and User C 220 since the keywords and their weight are dependent on the interactions. For example, tags cloud 205 is for User C as perceived by User D. Thus, as seen in FIG. 2 profiles (again, also referred to herein as cloud tags) are from a user's perspective in some embodiments of the present invention. Providing profiles from a user's perspective may increase usability and relevancy of profiles and information.

Turning back to FIG. 1, we provide more details for a usage model of the relationships of these tags clouds.

Opportunity Detector 155: This module monitors data generated by the sensors 165 in order to detect recommendation seeking opportunities for User A 105. For example, it might use information obtained from a web browsing activity and a physical location trace to detect that User A 105 is trying to research LCD TVs online and have visited an electronics store recently.

It will flag this as a situation that might require some recommendations from User A's social network. It will extract the metadata for the opportunity (similar to the way agents extract context metadata and keywords) and forwards the information to the next module.

Paths Recommender 160: The Paths Recommender, in general, can be queried by applications using a provided API, if the user gives the application in question the right to do so. These applications might be representing a simple usage model and would find a list of people in the social network to query about a topic. The Paths Recommender has access to User A's tags clouds repository. Using the metadata and weights information, it will perform a query to determine if there are relevant persons whose expertise or interests match a current opportunity. It will then sort the results and output the ordered list (the list may consist of tuples containing users that matched the query and a corresponding weight or relevance metric). It is noted that this list might get integrated into a bigger query for recommendations that can include professional reviewers such as Cnet®, or Consumer Reports®—although the present invention is not limited in this respect. Another method is to include these public professional reviewers as users that can be tracked by agents. In order to generate the ordered list for a topic X, the Paths Recommender can run either a “naïve query” where it will attempt to have an identical match on X, or a “context query” finding matches for the cluster of keywords that contain X. The clusters are obtained using techniques described in the Context Extractor.

Naïve Query: every user that has the keyword X assigned to them will be added to the list; the weight of that word is normalized and then added as the weight of the user. The final list of all the users that matched is ordered using the weights and outputted to the querying application.

Context Query: the keyword X is used to generate a list of keywords that are similar or fall within the same category. A weight multiplier is assigned for each of these keywords. Then, an individual “naïve query” for each keyword in the list is generated. The weights in the outputs of the “naïve queries” are multiplied by the respective keywords weights. Then the results are added, sorted and presented to the querying application.

The following is an example of the Paths Recommender queries. A call would look like this: find_recommenders_by_keyword (“Japanese restaurant”). The output would be a list of users and weights (or confidence level of how much we think this person is the one to go to for the topic). For our example, the output would be: <user X, 0.567>, <user Y, 0.429>, <user Z, 0.102>. The application might decide to query all of these users or the ones with a confidence level over a certain threshold. In other cases, these applications are more sophisticated and might query the Paths Recommender about several topics and then mash the results of these queries with additional information obtained either through sensors or other interfaces in order to provide a recommendation to the user. For example, using the above query for “Japanese restaurant” the application might mash that with GPS coordinates and then query only the persons who are in the vicinity of the user. Yet, in other cases, the application might issue a context query as such: find recommenders by context(“Japanese restaurant”). The Paths Recommender will spawn a query for every keyword in the cluster of “Japanese Restaurant”, which might looks like this “<restaurant, 0.9>,<Japanese restaurant, 1.0>, <sushi restaurant, 0.98>, <asian restaurant,0.5>, <food, 0.5>, <cooking, 0.4>, . . . ”. The results of the individual queries are multiplied by their respective weights and the final result might look something like this: “<user A, 0.862>, <user X, 0.472>, <user Z, 0.359>, <user Y, 0.215>”.

Tags Clouds Repository: this can reside in the cloud and be encrypted to be accessed only by the user that owns the information and their devices. In addition, the user might elect to make part of this public to other users and/or providers and services. The Repository can be also duplicated partially or fully to devices as needed, provided the approval of the user.

Embodiments of the present invention may further provide that each user have an agent for themselves that would define how they wish to represent themselves as well as what topics others perceive them as experts in. This can be created using the user's communications and interests as collected by the sensors. This self-“tags cloud” can then be wholly or partially published, depending on the user's preference. It can also be selectively published if the user wishes to do so. Note that the public clouds can be used with more or less weights depending on the settings and preferences of the user who is seeking the recommendations and owns the Paths Recommender. Of course, another extension to this would be for the system to tell the users how their clouds could be if they incorporate the publicly available information.

Still other embodiments of the present invention may provide other usage models. The usage model provided above is a pull model in which User A 105 is seeking information from their social network. These tags clouds can also be used in order to restrict, filter, and prioritize information in a push model. For example, when users in User A's 105 social network are broadcasting information, wherein a filter can be used to show relevant messages for User A. For example, if User B 225 who is a work acquaintance of User A 105 publishes the latest photos of their sea cruise, this information can be filtered and never presented to User A 105 who is unlikely to be interested. This filtering can occur either by an agent of User B 225 before sending, or by an agent of User A 105 before presenting received information to User A 105.

Still another embodiment of the present invention provides a system such as that shown generally as 100 of FIG. 1, comprising, an information assimilation and communication platform adapted to provide relationship characterization and utilization from a user's social networks, comprising, a monitoring agent for the user's social network to create a unique profile of each user of the social network by feeding data into a context aware framework and clustering raw data by extracting common interests and relevant keywords, thereby creating rich context-aware lists of keywords that characterize relationships among users of the social networks; and an interface to query the lists.

Yet another embodiment of the present invention provides a computer readable medium encoded with computer executable instructions, which when accessed, cause a machine to perform operations, comprising, creating relationship characterization and utilization from a user's social networks by using monitoring agents for the user's social network to create a unique profile of each user of the social network by feeding data into a context aware framework; clustering raw data by extracting common interests and relevant keywords, thereby creating rich context-aware lists of keywords that characterize relationships among users of the social networks; and providing an interface to query the lists.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method of relationship characterization and utilization from a user's social networks, comprising:
using monitoring agents for said user's social network to create a unique profile of each user of said social network by feeding data into a context aware framework; and
clustering raw data by extracting common interests and relevant keywords, thereby creating rich context-aware lists of keywords that characterize relationships among users of said social networks.

2. The method of claim 1, further comprising using a frequency of use of said keywords to define respective weights and wherein a constellation of said keywords creates a “tag cloud id”.

3. The method of claim 2, further comprising characterizing each edge of a social network, whether explicitly defined in social networking services and sites or not, that define a social graph with relevant topic/subject categories in an automated way.

4. The method of claim 3, wherein said clouds created are used to match persons in one's social network to keywords and sending a request for information and/or querying published data, or sending relevant information.

5. The method of claim 4, further comprising modules to accomplish said relationship characterization and utilization from a user's social network, said modules include: Sensors; Relationship Detectors; Agent Managers; Agents; Opportunity Detectors; and Paths Recommender.

6. The method of claim 5, wherein said agents are adapted to use Data Filtering, Context Extraction, and Context Weighing.

7. The method of claim 5, further comprising a Tags Clouds Repository residing in said cloud and encrypted to be accessed only by a user that owns information and devices.

8. The method of claim 1, further comprising a self-tags cloud which is an agent that is provided for each user that would define how said user wishes to represent themselves as well as what topics others perceive as their expertise or interests and wherein this is created using said user's communications and interests.

9. The method of claim 2, wherein said tag clouds are used in order to restrict, filter, and prioritize information in a push model.

10. A computer readable medium encoded with computer executable instructions, which when accessed, cause a machine to perform operations, comprising, creating relationship characterization and utilization from a user's social network by using monitoring agents for said user's social network to create a unique profile of each user of said social network by feeding data into a context aware framework;
clustering raw data by extracting common interests and relevant keywords, thereby creating rich context-aware lists of keywords that characterize relationships among users of said social networks; and
providing an interface to query said lists.

11. The computer readable medium encoded with computer executable instructions of claim 10, further comprising using a frequency of use of said keywords to define respective weights and wherein a constellation of said keywords creates a tag cloud id.

12. The computer readable medium encoded with computer executable instructions of claim 11, further comprising characterizing each edge of social network whether presented in one of the public services and sites or not, that define a social graph with relevant topic/subject categories in an automated way.

13. The computer readable medium encoded with computer executable instructions of claim 12, wherein said clouds created are used to match persons in one's social network to keywords and sending a request for information and/or querying published data.

14. The computer readable medium encoded with computer executable instructions of claim 13, further comprising said instructions controlling modules to accomplish said relationship characterization and utilization from a user's social networks, said modules include: Sensors; Relationship Detectors; Agent Managers; Agents; Opportunity Detectors; and Paths Recommender.

15. The computer readable medium encoded with computer executable instructions of claim 14, wherein said agents are adapted to use Data Filtering, Context Extraction, and Context Weighing.

16. The computer readable medium encoded with computer executable instructions of claim 15, further comprising said instructions creating a Tags Clouds Repository residing in said cloud and encrypted to be accessed only by a user that owns information and devices.

17. The computer readable medium encoded with computer executable instructions of claim 10, further comprising said instructions creating a self-tags cloud which is an agent that is provided for each user that would define how said user sees themselves as well as what topics others perceive them as experts in and wherein this is created using said user's communications and interests.

18. The computer readable medium encoded with computer executable instructions of claim 11, wherein said instructions cause said tag clouds to restrict, filter, and prioritize information in a push model.

19. A system, comprising:
an information assimilation and communication platform adapted to provide relationship characterization and utilization from a user's social network, comprising:
a monitoring agent for said user's social network to create a unique profile of each user of said social network by feeding data into a context aware framework and clustering raw data by extracting common interests with the user and relevant keywords, thereby creating rich context-aware lists of keywords that characterize relationships among users of said social network; and
an interface to query said lists.

20. The system of claim 19, further comprising using a frequency of use of said keywords to define respective weights and importance, and wherein a constellation of said keywords creates a tag cloud id.

21. The system of claim 20, further comprising characterizing each edge of a social network, including social networking services and sites, as well as other contacts, that define a social graph with relevant topic/subject categories in an automated way.

22. The system of claim 21, further comprising modules to accomplish said relationship characterization and utilization from a user's social networks, said modules include: Sensors; Relationship Detectors; Agent Managers; Agents; Opportunity Detectors; and Paths Recommender.

23. The method of claim 1, further comprising providing an interface to query and use said lists.
